(19) United States
(12) Patent Application Publication
(10) Pub. No.: US 2017/0311749 A1
(43) Pub. Date: Nov. 2, 2017

(54) Brewing Unit Apparatus of Coffee Machine and the Coffee Machine Thereof

(71) Applicant: Pui Yan Fung, Hong Kong (CN)

(72) Inventor: Pui Yan Fung, Hong Kong (CN)

(21) Appl. No.: 15/499,057

(22) Filed: Apr. 27, 2017

(30) Foreign Application Priority Data
Apr. 27, 2016 (HK) 16104850.3

(51) Int. Cl. A47J 31/40

(52) U.S. Cl. CPC A47J 31/404

(57) ABSTRACT

A brewing unit apparatus of a coffee machine and the coffee machine thereof is adapted to accommodate and brew a coffee powder in the coffee machine. The apparatus comprises a filter sieve for accommodating the coffee powder. The sieve is arranged in a unit component body. An inlet is arranged in an upper portion of the unit component body. An outlet is arranged in a lower portion. A step space for allowing the coffee powder expansion and avoiding overflow extends between an upper edge of the sieve and an upper portion of the unit component body.

### FIELD OF THE INVENTION

The present disclosure relates to a coffee machine and an accessory thereof, and, more particularly, relates to a coffee machine and an improvement for the coffee extracting and filtering apparatus thereof.

### BACKGROUND

Since coffee powder needs to be brewed and extracted before utilization, in the prior art coffee machine, a brewing and extracting component dealing with the coffee powder is a core component of the coffee machine. In order to ensure the tasty qualities of concentration and temperature of the extracted coffee, the common coffee powder brewing and extracting parts, such as Keurig® My K-Cup® , Ekobrew™ brands coffee brewing unit devices, continue to improve the coffee brewing unit device.

According to a standard of SCAA (Specialty Coffee Association of America), a best coffee brewing and extracting ratio is 1000 ml water to 55 g coffee powder, that is, a ratio requirement of 0.055 is adopted for an optimum coffee taste. However, in the prior art, improvements for a coffee brewing unit tend to generally focus on an accommodation sieve for coffee, i.e., a filter sieve. There appears to be no precedent examples on designing and considering an amount of coffee powder to be accommodated. For most coffee brewing units in the prior art, a method of arranging a maximum capacity mark on the coffee filter sieve, or on a unit component holding the coffee filter sieve, is adopted to indicate an optimum coffee powder amount. However, for such a method in one aspect, a user has difficulty in controlling the amount of coffee to be poured. In another aspect, since no careful consideration on coffee capacity is accounted for in the structure, when the coffee powder fills the filter sieve, there is no design consideration on coffee powder expansion during the process of brewing and extraction, which causes the coffee powder to overflow, affecting the coffee taste.

Therefore, the current technology needs to be improved and developed.

### SUMMARY

The purpose of the present disclosure is to provide an improved brewing unit apparatus of a coffee machine and the coffee machine thereof. Through improving the brewing unit apparatus of the coffee machine, control of the coffee brewing ratio is conveniently achieved.

A brewing unit apparatus of a coffee machine for accommodating and brewing a coffee powder in a coffee machine comprises a filter sieve for accommodating the coffee powder. The sieve is arranged in a body of a unit component. An inlet is arranged in an upper portion of the unit component body. An outlet is arranged in a lower portion. A step space for allowing the coffee powder expansion and avoiding overflow is disposed between an upper edge of the sieve and an upper portion of the unit component body.

At the inner bottom of the unit component body, a filtration space facilitating a convergence of the coffee extract is disposed between the outlet and the sieve bottom.

The sieve is made of a metal mesh, and both the bottom and sides of the sieve are made of metal meshes.

The sieve has a cup shape.

The unit component body is further arranged with a cover component. A downwardly arranged cylindrical portion and a tapered portion is arranged on the cover component, and a plurality of downward inlets are arranged in the tapered portion.

A water conducting cap is disposed on an outside of the cover component.

The cover component has an integrated connection portion arranged for connecting with the unit component body and acting as an axle for flipping or pivoting the cover component. A notch is disposed on an opposite side of the unit component body with respect to the integrated connection portion, and a flange portion is disposed on the cover component for facilitating the opening of the cover component.

The cover component has a circular rubber ring.

The brewing unit apparatus described above is incorporated in a coffee machine.

The present disclosure provides a brewing unit apparatus of a coffee machine and the coffee machine thereof providing a step space disposed in the brewing unit apparatus for allowing the coffee powder expansion and avoiding overflow. The apparatus aids a user in controlling the amount of the coffee powder during brewing of the coffee powder, and a more convenient coffee machine usage is achieved.

### BRIEF DESCRIPTION OF THE DRAWINGS

FIG. 1 illustrates a schematic exploded perspective view of the brewing unit apparatus of the coffee machine consistent with various disclosed embodiments of the present disclosure.

FIG. 2 illustrates another exploded perspective view of the filter sieve of the brewing unit apparatus of the coffee machine consistent with various disclosed embodiments of the present disclosure.

FIG. 3 illustrates a partial cross-sectional diagrammatic view of the brewing unit apparatus of the coffee machine and the coffee machine thereof consistent with various disclosed embodiments of the present disclosure.

FIG. 4 illustrates a side view of the unit component of the brewing unit apparatus of the coffee machine and the coffee machine thereof consistent with various disclosed embodiments of the present disclosure.

FIG. 5 illustrates a bottom view of the unit component of the brewing unit apparatus of the coffee machine and the coffee machine thereof consistent with various disclosed embodiments of the present disclosure.

FIG. 6 illustrates a schematic view of a coffee machine incorporating the brewing unit apparatus.

### DETAILED DESCRIPTION

For those skilled in the art to better understand the technical solution of the invention, reference will now be made in detail to exemplary embodiments of the invention, which are illustrated in the accompanying drawings. Wherever possible, the same reference numbers will be used throughout the drawings to refer to the same or like parts.

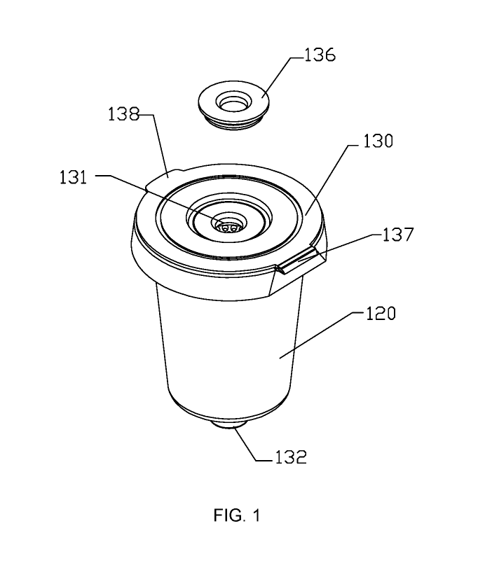

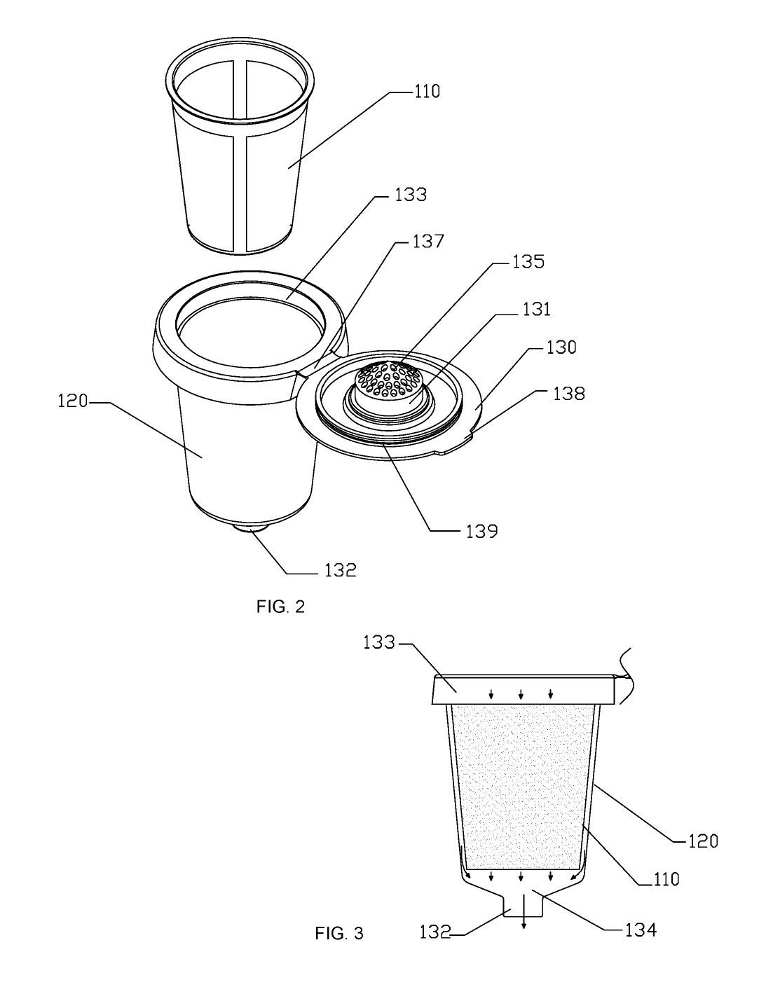

A preferred embodiment of a brewing unit apparatus of a coffee machine and the coffee machine thereof described in the present disclosure, as shown in FIG. 2, comprises a filter sieve 110 adapted for accommodating a coffee powder or coffee grounds. The sieve 110 is cup shaped, may employ a plastic frame portion, and has a full metal filtration mesh in both the side and bottom. The sieve 110 is arranged in a body of a unit component 120, and there is an inner recession arranged in the body, which substantially matches the sieve. An inlet 131 is arranged on an upper portion of the body. Preferably, it is arranged as a cover component 130. An outlet 132 is arranged on a bottom of the body, as shown in FIG. 1 and FIG. 2.

When arranging the sieve 110 in the unit component 120, it is arranged to provide step space 133 on an upper edge of the sieve 110 to an upper portion of the body of the unit component 120, shown in FIG. 3 (both the sieve 110 and the unit component 120 shown in the figure have omitted a side thickness). The step space 133 allows an expansion of the coffee powder and avoids an overflow. In such a way, during a practical use, a user may fill the coffee powder up to the sieve 110 (or slightly less). When pouring hot water through the inlet 131, the step space 133 may store some water. Preferably, when the coffee powder is under brewing and extracting, it may expand to the step space 133, instead of overflowing out of the unit component 120. A height of the step space 133 may be arranged as required, such as 10-20 mm. The sieve 110 is arranged on an edge of the step space 133 in the unit component 120.

In order to facilitating the brewing and extracting of the coffee powder, both sides and bottom of the sieve 110 are arranged as metal meshes. A gap is arranged at an inner wall of the unit component 120. As shown in FIG. 3, a direction of an arrow is the direction of a water flow. Preferably, on the bottom, between the outlet 132 and the bottom side of the sieve, there is a filtration space 134 arranged for facilitating the coffee extract convergence in such a way that the coffee extract may be converged quickly. Of course, to achieve a requirement of different tastes, a plurality of gaps with different width may be adopted between the sieve 110 and the inner wall of the body of the unit component 120, and the filtration space 134 may adopt a smaller space to control a flow out speed of an extracted coffee solution, so as to control or regulate a concentration and the taste of the coffee.

The outlet 132 is arranged on the bottom of the unit component 120 in the present disclosure, forming an integrated channel going downward from the body. However, due to an existence of the filtration space 134, it may control to the extent that an extraction and filtration process be finished quickly.

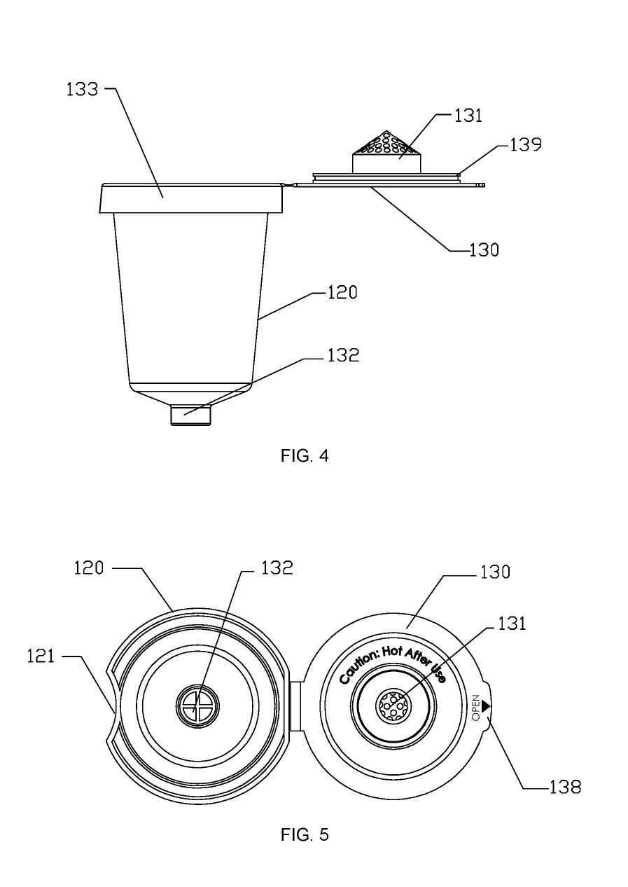

On the cover component 130 described in the present disclosure, as shown in FIG. 4 and FIG. 5, a water showering component is arranged facing inside of the body of the unit component 120 so that hot water may be poured downward. The unit component 120 is integrated with the cover component 130 which has a cylinder shaped neck and a tapered bottom and forms the inlet 131. On a plurality of sides of the tapered shape, a plurality of downward water conducting holes 135 are arranged. A size of each hole and a water conduction direction may be set according to a requirement of a brewing and extracting speed.

The cover component 130 in the present disclosure further has a water conducting cap 136 as shown in FIG. 1, which is arranged at a center of the cover component 130. The conducting cap 136 converges and forms the flow of downwardly injected water for extraction. The cover component 130 in the present disclosure has an integrated connection portion 137 connecting to the unit component body. The connection portion acts as an axle for flipping or pivoting the cover component 130. A notch 121 is arranged on an outer edge of another side of the body of the unit component 120 with respect to the integrated connection portion, as shown in FIG. 5. A flange portion 138 is arranged accordingly on the cover component 130 for facilitating the opening of the cover component 130 from the unit component 120, and facilitating loading the sieve 110 with the coffee powder in the unit component 120.

To facilitate the cover component 130 sealing the body of the unit component 120, a circular rubber ring 139 is further arranged on the cover component 130, shown as FIG. 2 and FIG. 4. The rubber ring 139 closely contacts with the inner wall of the body where the step space 133 is located, so that water vapor during a coffee powder extraction may be sealed.

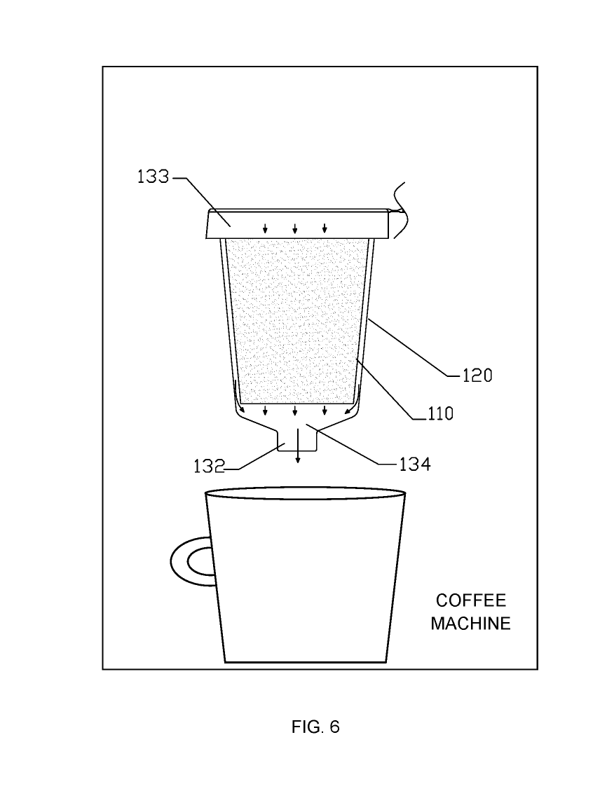

For the brewing unit apparatus of the coffee machine and the coffee machine thereof described in the present disclosure, a preferred embodiment further includes the coffee machine incorporating the above listed brewing unit apparatus in the preferred embodiments described above, as schematically illustrated in FIG. 6. Other structures of the coffee machine besides the brewing unit apparatus are not illustrated.

The present disclosure provides a brewing unit apparatus of a coffee machine and the coffee machine thereof. Due to adopting a preserved step space 133, a full utilization to the filter sieve is achieved, and the capacity may be fully accommodated by the coffee powder, while during extracting, the coffee powder is allowed to expand in the step space 133 without any overflow, so that the accommodation space for the coffee powder may be increased, more coffee powder may be held, and the SCAA ratio requirement of 0.055 may be met more easily. A design of a big shower head of a cylinder shape together with a tapered shape arranged on the cover component 130 may improve an extraction degree, so as to improve the coffee concentration, in order to achieve more easily controlled different coffee tastes, to make the coffee taste reach the best state.

It should be understood that, the application of the present disclosure is not limited to the above examples listed. Ordinary technical personnel in this field can improve or change the applications according to the above descriptions. All of these improvements and transformations should belong to the scope of protection in the appended claims of the present disclosure.

1. A brewing unit apparatus of a coffee machine to accommodate and brew a coffee powder comprising a filter sieve for accommodating the coffee powder, the sieve being arranged in a body of a unit component, and an inlet being arranged in an upper portion of the unit component body, and an outlet being arranged in a lower portion of the unit component body wherein a step space for allowing the coffee powder expansion and avoiding overflow is defined and arranged on an upper edge of the sieve and an upper portion of the unit component body.

2. The brewing unit apparatus according to claim 1 wherein at an inner bottom of the unit component body, a filtration space facilitating a convergence of a coffee extract is arranged between the outlet and a bottom of the sieve.

3. The brewing unit apparatus according to claim 2 wherein the sieve has a bottom and sides and comprises a metal mesh, and the bottom and sides of the sieve are made of metal mesh.

4. The brewing unit apparatus according to claim 3 wherein the sieve has a cup shape.

5. The brewing unit apparatus according to claim 4 wherein the unit component body further has a cover component with a downwardly arranged cylindrical portion and tapered portion, and a plurality of downward inlets are arranged in the tapered portion.

6. The brewing unit apparatus according to claim 5 wherein a water conducting cap is arranged on an outside of the cover component.

7. The brewing unit apparatus according to claim 6 wherein the cover component has an integrated connection portion arranged for connecting with the unit component body and acting as an axle for flipping the cover component, a notch is disposed on an opposite side of the unit component body with respect to the integrated connection portion, and a flange portion is arranged on the cover component for facilitating opening the cover component.

8. The brewing unit apparatus according to claim 7 wherein, on the cover component, a circular rubber ring is disposed.

9. The brewing unit apparatus according to claim 8 wherein the rubber ring is sealable against the upper portion of the unit component body.

10. A coffee machine incorporating the brewing unit apparatus of claim 1.

11. A coffee machine incorporating the brewing unit apparatus of claim 2.

12. A coffee machine incorporating the brewing unit apparatus of claim 3.

13. A coffee machine incorporating the brewing unit apparatus of claim 4.

14. A coffee machine incorporating the brewing unit apparatus of claim 5.

15. A coffee machine incorporating the brewing unit apparatus of claim 6.

16. A coffee machine incorporating the brewing unit apparatus of claim 7.

17. A coffee machine incorporating the brewing unit apparatus of claim 8.

18. A coffee machine incorporating the brewing unit apparatus of claim 9.
